(19) United States
(12) Patent Application Publication
(10) Pub. No.: US 2013/0246381 A1
(43) Pub. Date: Sep. 19, 2013

(54) GEO SIGNAL SEARCH RESULT

(71) Applicants: Ashutosh Garg, Sunnyvale, CA (US); Kedar Dhamdhere, Sunnyvale, CA (US)

(72) Inventors: Ashutosh Garg, Sunnyvale, CA (US); Kedar Dhamdhere, Sunnyvale, CA (US)

(73) Assignee: Google Inc., Mountain View, CA (US)

(21) Appl. No.: 12/245,455

(22) Filed: Oct. 3, 2008

(51) Int. Cl. G06F 7/06; G06F 17/30; H04L 29/06

(52) U.S. Cl. 707/706; 707/E17.014; 707/E17.018; 707/708

(57) ABSTRACT

Methods, systems, and apparatus, including computer program products, for ranking search results. In one aspect, a document provided to a user device is identified. In addition, a geographic location is identified by the content of the document. User queries are received and search results are identified and ranked based, at least in part, on the geographic location.

### FIELD

This specification relates to generating search results relevant to geographic signals.

### BACKGROUND

The rise of the Internet has enabled access to a wide variety of content items, e.g., video files, audio files, web pages for particular subjects, and news articles. Content items can be identified by a search engine in response to a user query. The content items may be of particular interest to a user. One example search engine is the Google® search engine provided by Google Inc. of Mountain View, Calif., U.S.A. The queries can include one or more search terms or phrases, and search engines generally identify and rank the content items based on the search terms or phrases in the query, and then present the content items to the user (e.g., in order according to the rank).

Typically, publishers and advertisers can add geographical identification metadata to content items. A search engine can use the geographical identification metadata, and data indicating a user's current geographic location, to identify search results relevant to the user's current geographic location.

### SUMMARY

In general, one aspect of the subject matter described in this specification can be embodied in methods that include the actions for ranking search results. The method includes receiving a document provided to a user device, the document including content that is presented on the user device; determining a geographic location identified by the content of the document; receiving a query from the user device; identifying search results that are responsive to the query; and ranking the search results based at least in part on the geographic location. Other embodiments of this aspect include corresponding systems, apparatus, and computer program products.

These and other embodiments can optionally include one or more of the following features. The document can be a news article document. Determining a geographic location identified by the content of the document can include determining the geographic location independent of a current location of a user device. Determining a geographic location identified by the content of the document can also include identifying the geographic location of the document publisher. Ranking the search results based, at least in part, on the geographic location can include increasing the rank of search results that include information about a geographic location relative to search results that do not include information about the geographic location. The geographic location can be a country. In some embodiments, ranking the search results can include promoting the search results that are relevant to the country.

In another aspect, another method for ranking search includes receiving a search query from a user device; identifying a first location described in an article selected at the user device; identifying search results associated with the query; and ranking the search results based on the first location so that the search results are ranked in proportion to their relevance to the first location. Other embodiments of this aspect include corresponding systems, apparatus, and computer program products.

In general, one aspect of the subject matter described in this specification can be embodied in a system. The system can include a processor and a computer-readable medium. The computer-readable medium can be coupled to the processor and include instructions stored thereon, which, when executed by the processor, causes the processor to perform operations that include receiving a search query from a user device, identifying a first location described in an article selected at the user device, identifying search results associated with the query, and ranking the search results based on the first location so that the search results are ranked in proportion to their relevance to the first location.

In another general aspect, the subject matter described in this specification can be embodied in a system that increases the rank of search results that include information about a geographic location relative to search results that do not include information about the geographic location. The document can include content that is presented on the user device.

These and other embodiments can optionally include one or more of the following features. The processor can identify a geographic location of a document publisher. The processor can be operable to perform operations including increasing the rank of search results that include information about the geographic location relative to search results that do not include information about the geographic location. The processor can be further operable to determine the geographic location independent of a current location of a user device.

Particular embodiments of the subject matter described in this specification can be implemented so as to realize one or more of the following advantages. Identifying and ranking user-relevant search results can be based on the geographic location identified in the content of a document. In particular, a search relevancy score can be increased when a search result can be geographically associated with a geographic location of the document publisher of the website. Another advantage of inferring country of interest for the user is to use it to infer which languages the user might be familiar with. For instance, if a user's inferred country is France, then it's likely that the user understands French, hence it is okay to show the user web pages written in French.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example online environment that includes a query processing system that uses a geographic location to identify search results.

FIG. 2A depicts an example screen shot of a newspaper website.

FIG. 2B depicts example screen shots of a search engine interface.

FIG. 3A depicts an example screen shot of another newspaper website.

FIG. 3B depicts example screen shots of a search engine interface.

FIG. 4 is a flow diagram of an example process for ranking search results.

FIG. 5 is a flow diagram of another example process for ranking search results.

Like reference numbers and designations in the various drawings indicate like elements.

### DETAILED DESCRIPTION

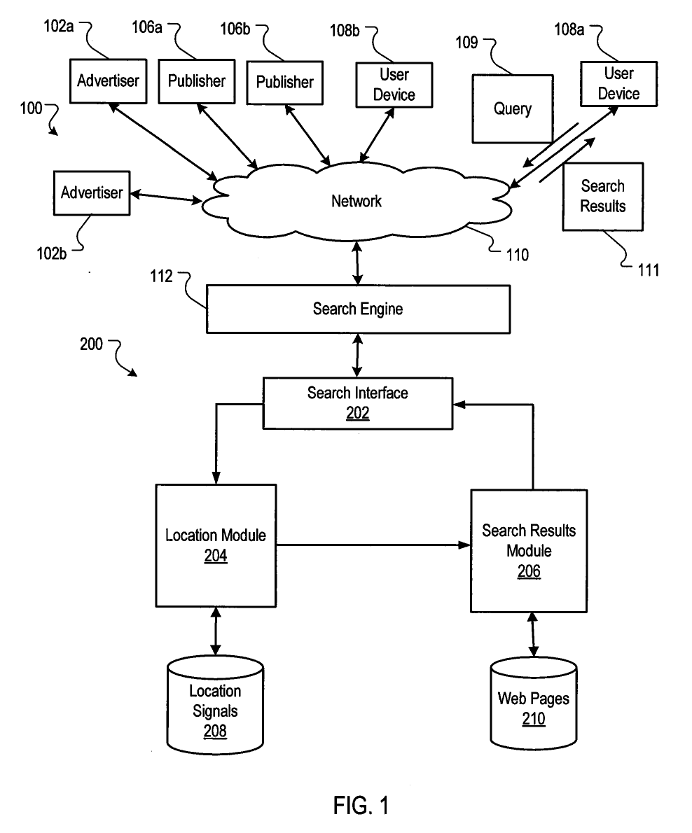

FIG. 1 is a block diagram of an example online environment 100 that includes a query processing system 200 that uses a geographic location to identify search results. The online environment 100 facilitates the identification and serving of content items, e.g., web pages, news feeds, advertisements, and other documents, to users. A computer network 110, such as a local area network (LAN), wide area network (WAN), the Internet, or a combination thereof, connects advertisers 102a and 102b, a search engine 112, publishers 106a and 106b, and user devices 108a and 108b. Example user devices 108a or 108b include personal computers, mobile communication devices, television set-top boxes, etc. Although only two advertisers (102a and 102b), two publishers (106a and 106b), and two user devices (108a and 108b) are shown, the online environment 100 may include many thousands of advertisers, publishers, and user devices.

The publishers 106a and 106b can include general content servers that receive requests for content (e.g., web pages or documents related to articles, discussion threads, music, video, graphics, other web page listings, information feeds, product reviews, etc.), and retrieve the requested content in response to the request. For example, content servers related to news content providers, retailers, independent blogs, social network sites, products for sale, or any other entity that provides content over the network 110 can be a publisher.

A user device, such as user device 108a, can submit a query 109 to the search engine 112, and search results 111 can be provided to the user device 108a in response to the query 109. The search results 111 can include a link to web pages provided by the publishers 106a and 106b.

To facilitate identification of the search results responsive to queries, the search engine 112 indexes the content provided by the publishers 106a or 106b (e.g., an index of web pages) for later search and retrieval of search results that are relevant to the queries. An example search engine 112 is described in S. Brin and L. Page, “The Anatomy of a Large-Scale Hypertextual Search Engine,” Seventh International World Wide Web Conference, Brisbane, Australia (1998) and in U.S. Pat. No. 6,285,999. Search results can include, for example, lists of web page titles, snippets of text extracted from those web pages, and hypertext links to those web pages, and may be grouped into a predetermined number (e.g., ten) of search results.

In some implementations, the search engine 112 utilizes different information from the query and from prospective results to rank the search results. Such information may include, for example, identifiers related to the search results (e.g., document identifiers), scores related to the search results (e.g., information retrieval (“IR”) scores), snippets of text extracted from identified documents (e.g., web pages), full text of identified documents, geographic location information, feature vectors of identified documents, etc. In some implementations, IR scores can be computed from, for example, dot products of feature vectors corresponding to a query and a document, page rank scores, and/or combinations of IR scores and page rank scores, etc.

Users generally desire that the search queries find search results that are most responsive to a user's interest. While an IP address of a user's device can provide data indicating a potential geographic location of interest, the user may have other locations of interest. For example, a user from France and traveling in the United States may care much more about articles about French sports teams when surfing the web in the United States than about articles about United States sports teams.

In some implementations, these other locations of interest can be identified by a geographic location signal (“geo signal”). The geo signal identifies a particular location of interest for a user and can be determined from content that is selected by the user. The geo signal can include geographical location information identifying where a selected content item originated (e.g., city, state, or country). The geo signal can be provided to a search engine, which, in turn, uses this geographic location information to find search results that are most responsive to a user's interest.

In some implementations, the geo signal is determined from online newspapers a particular user accesses most often. The geo signal can provide a search engine with information about which newspapers a specific user accesses. The origin of the content publisher (of the newspaper) can then be identified as a secondary geographic location of interest for a particular user. The geo signal can be explicit (coded as metadata into the newspaper) or implicit (derived from the content of the newspaper).

In some implementations, the search engine 112 can include a query processing system 200 that can identify the geo signal related to the geographical location of the subject of a document or document publication, and can use the geo signal to rank search results in proportion to their relevance to the geographical location. For example, the query processing system 200 can identify a geo signal for use in a search session from previous web pages a user has visited, and then use the geo signal to rank search results from a search query and provide the most geographically relevant search results while demoting less geographically relevant search results. The system 200 receives a query from a user device and identifies search results that are associated with the received query. The system 200 can then rank the search results based on the determined location such that the search results are ranked in proportion to the search result's relevance to the geographic location. The system 200 can thus generate a ranked list of search results based, in part, on a geo signal that is determined from a user's selection of documents (e.g., news stories) and that is independent of the user's current location.

As shown in FIG. 1, the search query processing system 200 includes a search interface 202, a location module 204, and a search results module 206. The search interface 202 can receive a search query associated with a search session. The search query can include one or more search terms. For example, a user can submit queries when searching for a particular topic

The location module 204 can identify a geographic location described in an article or document. In some implementations, the module 204 can identify a first location described in a document selected at a user device. The first location may include a geographic location described in the document, such as a country, state, or city, for example. The location can, for example, be identified by comparing the content of the document to a data store of geographic location data, such as the locations signals database 208. For example, the document may be a news article for a newspaper that is published in a geographic location of interest to the user, e.g., a user's hometown.

The search results module 206 can identify search results that are relevant to an entered query received by the search interface 202. For example, the search results module 206 can search for information on the Web, such as web pages, advertisements, images, newsgroups, databases, and other types of files. The search results module 206 can implement various techniques to narrow a search result list to relevant results. For example, the search results module 206 can receive geo signal information or other location information from the location module 204 and use the information to rank a set of search results according to a particular user's geographical interests.

The location signals database 208 includes various geographical identifiers. The geographical identifiers generally describe a location. In some implementations, the location signals database 208 includes coordinate based geographical identifiers, such as latitude and longitude coordinates, etc. In other implementations, the location signals database 208 includes non-coordinate based geographical identifiers, such as postal addresses, places of interest, etc.

The web pages database 210 includes files of static text stored within the system 200 file system (e.g., static web pages). In some implementations, the system 200 can use web pages database 210 to construct (X)HTML for each stored web page when it is requested by a browser (e.g., dynamic web pages).

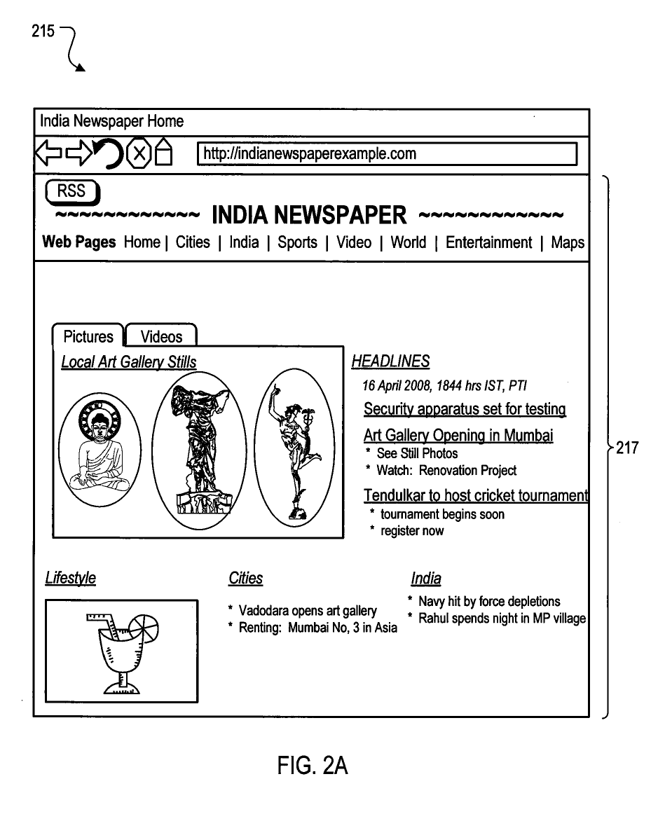

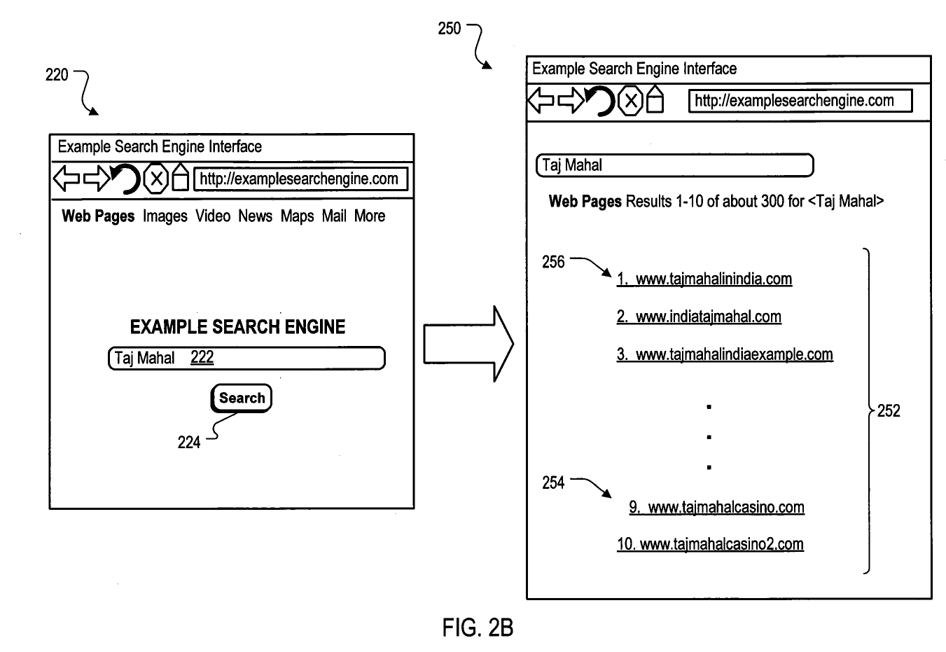

FIG. 2A depicts an example screen shot of a newspaper website 300. In particular, the screen shot 215 illustrates an online newspaper, namely, “India Newspaper.” As is typical in an online newspaper site, site 215 includes a homepage 217. The homepage 217 may include a search bar, links, headlines, images, ads, RSS feeds, video, and other content. In some implementations, more or less content can be displayed in page 217.

In general, a user can access the homepage 217 to select and peruse various headlines, pictures, videos, and other information in the online newspaper. For example, a user may access the online India Newspaper to keep abreast of news in the country of India. The user can access the newspaper and related articles by opening the website http://indianewspaperexample.com. In some implementations, the user may be asked to log into the newspaper site or in some cases can be recognized from a previous visit where the website may automatically log in the user. In other implementations, the user accesses the online newspaper without logging in.

FIG. 2B depicts example screen shots (220 and 250) of a search engine interface. The screen shot 220 shows a search query 222 that includes the search terms “Taj Mahal.” A user can, for example, enter the search query 222 in the example search engine interface 220 to find search results relative to the entered search terms. After entering the search query 222, the user can select a search button 224 to submit the query 222 to the search engine 112, for example. Upon receiving the search query 222, the location module 204 can analyze the query. In the analysis, the location module 204 can retrieve geographic location information from the user device accessing the search engine interface. For example, the location module 204 can acquire geo signal information related to the user's actions on the user device, such as websites accessed previously. In some implementations, the location module 204 can retrieve information that the user visited the India Newspaper website shown in FIG. 2A. From this data, the location module 204 can determine the location of the newspaper publisher. In some implementations, the location module 204 can use geographic location information to determine a location simply described in the newspaper site.

In some implementations, the location module 204 can access information in the geographic location information that was previously stored before a user performs searching functions. For example, if the user regularly visits the “indianewspaperexample.com” website (FIG. 2A), the location module 204 can associate the geographic location of the regularly visited site with a “location of interest” to the user. As a result, the system 200 may be more likely to provide search results relative to the country of India or topics and articles that cover Indian content. The location of interest can include a country, a state, a region, a city, or any combination of places of interest. This location of interest can be used to promote or demote search results that may be presented to the user.

As an example, the screen shot 220 depicts a search engine interface where a user is searching for articles or web pages that include the search tokens “Taj Mahal.” Here, the geo signal may be used to associate the country of India (e.g., the document publisher's geographic location) with the interests of the user regardless of the location of the user device. Once the geographic location of the document publisher is determined from the geo signal or other geographical location information, the location module 204 can provide the location information to the search results module 206. The search results module 206 can then use the location information to increase the rank of search results that include information about the geographic location relative to search results that do not include information about the geographic location.

In some implementations, the location module 204 processes the search query and provides relevant geographic location information to the search results module 206. For example, the location module 204 identifies a geographic location based on a user's regularly accessed newspaper (e.g., India Newspaper).

Upon determining the geographic location interests, the location module 204 can provide the location information to the search results module 206. The search results module 206 can use the location information to rank the search results according to one or more of the user's geographical locations of interest.

As shown in screen shot 250, ranked search results 252 are displayed to a user. Since the location module 204 may previously determine that India is a geographic location of interest to this particular user, the search results module 206 can rank the list of search results according to the identified location. For example, if the geographic location of interest is the country of India, the search results module 206 can promote the search results in list 252 that are most relevant to the country of India. Similarly, the search results module 206 can demote the search results 252 that are not relevant to India. For example, the search result 254 (www.tajmahalcasino.com) for the Taj Mahal Casino may be less relevant than the search result 256 (www.tajmahalinindia.com) for the Taj Mahal in India.

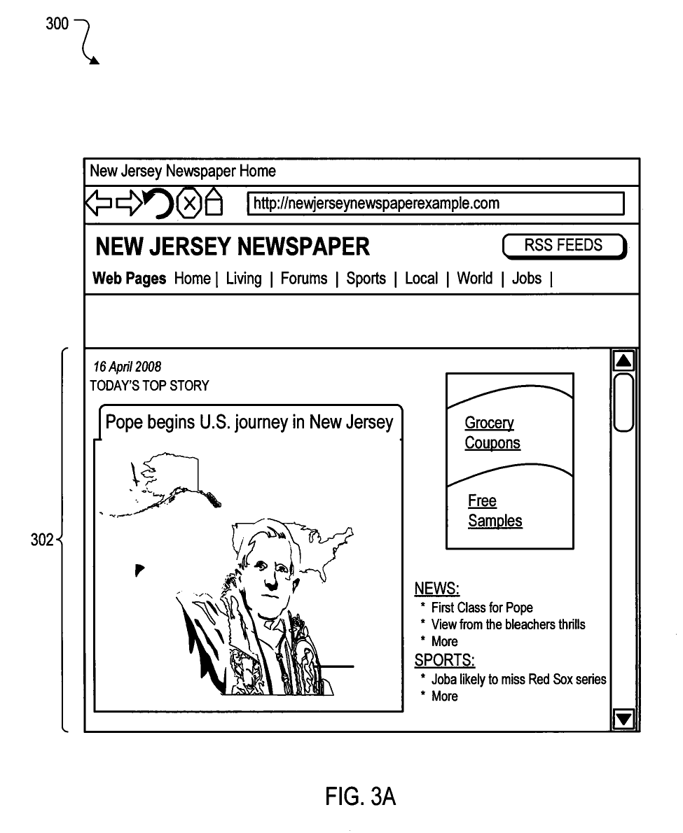

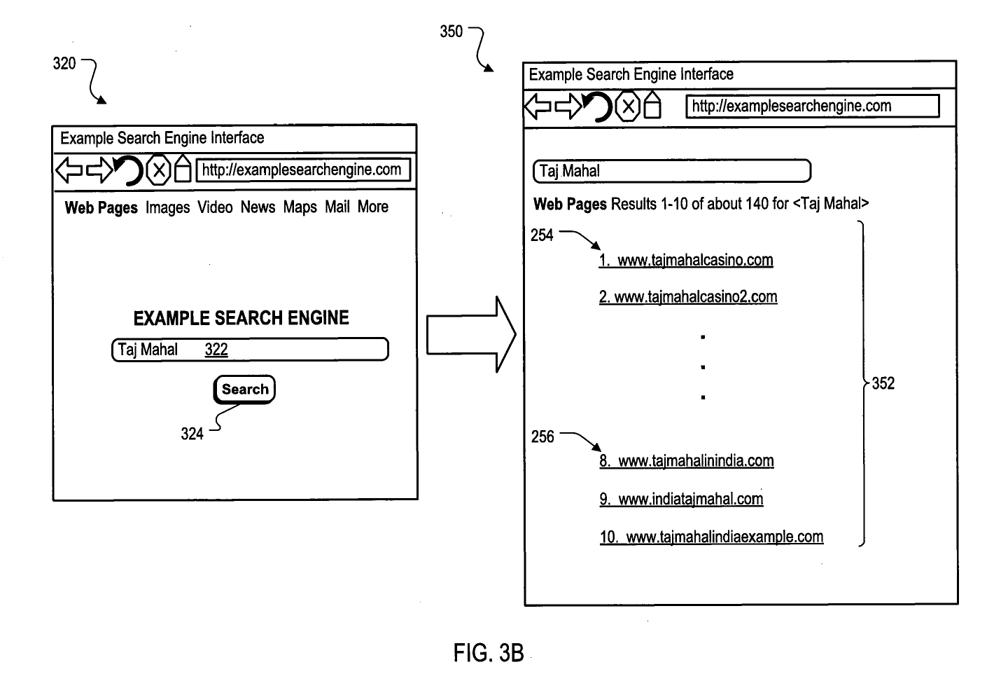

FIG. 3A depicts an example screen shot 300 of another newspaper website. In particular, the screen shot 300 illustrates an online newspaper, namely, “New Jersey Newspaper.” Similar to the example 215, site 300 includes a homepage 302. The homepage 302 may include a search bar, links, headlines, images, ads, RSS feeds, video, and other content. In some implementations, more or less content can be displayed in page 302.

FIG. 3B depicts example screen shots (320 and 350) of a search engine interface. The screen shot 320 shows a search query 322 that includes the search terms “Taj Mahal.” A user can, for example, enter the search query 322 in the example search engine interface to find search results relative to the entered search terms. After entering the search query 322, the user can select a search button 324 to submit the query 322 to the search engine. Upon receiving the search query 322, the location module 204 can analyze the query. In the analysis, the location module 204 can retrieve geographic location information from the user device accessing the search engine interface. In some implementations, the location module 204 can retrieve information that the user visited the New Jersey Newspaper website shown in FIG. 3A. From this data, the module 204 can determine the location of the newspaper publisher. In some implementations, the geographic location can be identified based on a user's selection of articles (e.g., news stories on a webpage).

As shown in screen shot 350, ranked search results 352 are displayed to a user. Since the location module 204 previously determined that New Jersey may be a geographic location of interest to this particular user, the search results module 206 can rank the list of search results according to the identified location. For example, if the geographic location is New Jersey, the search results module 206 can increase a search relevancy score of a search result that includes information relevant to New Jersey. In some implementations, the system 200 can determine preferences according to a retrieved geo signal. For example, the user who is interested in the geographic location of New Jersey may be more likely to enter the “Taj Mahal” query 322 to retrieve content relevant to a local New Jersey casino named The Taj Mahal Casino rather than the historical Taj Mahal of India. Accordingly, the search results module 206 can use the geographic location information to increase the relevancy score of the search result 254 (www.tajmahalcasino.com), thereby promoting the result 254. Similarly, the Taj Mahal search result 256 (www.tajmahalinindia.com) can be demoted because the geographic location information of search result 256 pertains to India, rather than New Jersey, United States.

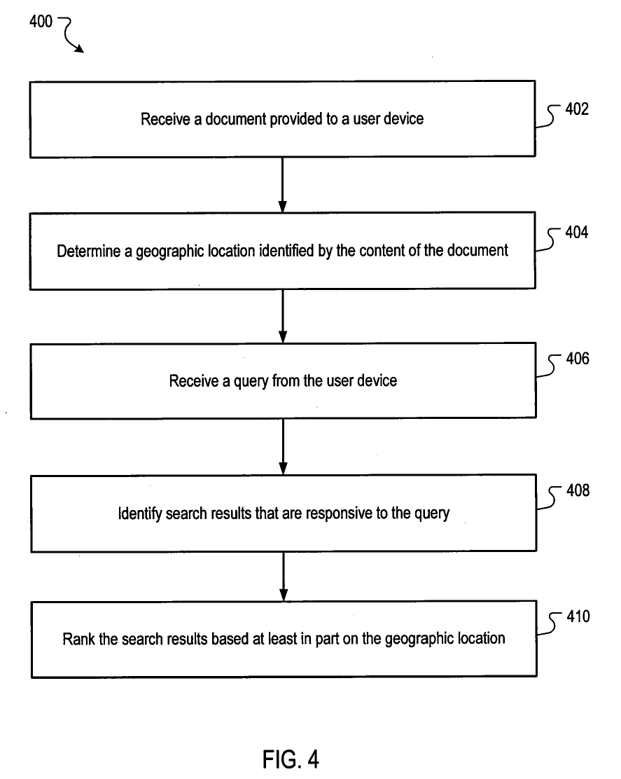

FIG. 4 is a flow diagram of an example process 400 for ranking search results. The process 400 can, for example be performed by the system 200. For illustrative purposes, the process 400 shall be described in reference to the architecture shown in FIG. 1; although it should be understood the process 400 can be applied to different architecture configuration other than FIG. 1.

The process 400 receives a document provided to a user device (402). For example, the search results module 206 receives a document including online content, such as a newspaper article stored in web pages 210 that can be presented on a user device. Other provided content can be identified on a particular user device including, but not limited to, web pages, advertisements, images, audio content, web feeds (e.g., RSS, Atom, APP, etc.).

The process 400 determines a geographic location identified by the content of the received document from step 402 above (404). For example, the location module 204 determines a geographic location based on the user's selection of articles (e.g., news stories on a webpage). The geographic location information can, for example, be included as metadata within an online newspaper site. The geographic location may pertain to the originating city, state, or country that produced the newspaper. In short, the location module 204 can, for example, use a geo signal or other geographic location information to determine the location of the document publisher of a selected article, blog, advertisement, or some other document, independent of the location of the user device accessing the newspaper article document.

The system 200 receives a query from a user device (406). For example, the search interface 202 receives a query including the search tokens “New York Co,” and this query can be provided to the location module 204. Another example is a search query for “environmental events, NYC.” In the two examples above, the user may be searching for content related to New York City environmental events or companies. Alternatively, the user may be searching for an event occurring at a local “New York & Company” clothing store.

The process 400 identifies search results that are responsive to the query (408). For example, if the query is from the above example, namely “environmental events, NYC,” the search results module 206 identifies one or more search results that provide geo signal information about New York City events. In some implementations, the search results can be identified using standard keyword matching, popularity statistics, search engine settings, and other information narrowing techniques.

The process 400 ranks the search results based at least in part on the geographic location (410). For example, the search results module 206 uses predetermined geographic location information derived from a user's previous queries, site visits, or other actions to increase the rank of search results that include information about the geographic location relative to search results that do not include information about the determined geographic location. In some implementations, the geographic location may include the geographic location of the document publisher. In some implementations, the geographic location used may include the current location disclosed in an article provided in one of the search results. For example, if the user accesses a New York newspaper and later performs a search for ballet events, a geo signal may identify New York as a geo location of interest for the search and the system 200 may provide search results most relevant to ballet events occurring in New York.

In some implementations, the search results module 206 may rank the search results. The ranking of search results may include increasing a relevancy score of a particular search result if, for example, the result includes information relatable to the geographic location indicated by the geo signal. In some implementations, geographic locations can be associated with a newspaper which provides information about a local place. The location module 204 can, for example, use the geographic location of the newspaper a user accesses to determine a location of interest other than physical user location. For example, a user from London, England may travel to New York City, United States and access LondonTimes.com to keep abreast of local European news. The geographic location of the London Times newspaper can be stored in the location signals database 208 and applied to search queries at some point in the future.

As an example, a user accessing LondonTimes.com may have an interest in European news, rather than the news provided by the user's actual geographic location (e.g., New York). Once the geographic location information is stored, the search results module 206, for example, can appropriately apply a ranking scheme that promotes the relevancy scores for search results more pertinent to the country of England or the specific London location. Similarly, the search results module 206 can, for example, demote relevancy scores for returned search results which are less relevant to the country of England.

In some implementations, the ranked search results can be presented to the user in a search engine session. In other implementations, the ranked search results can be stored and accessed at a later point in time.

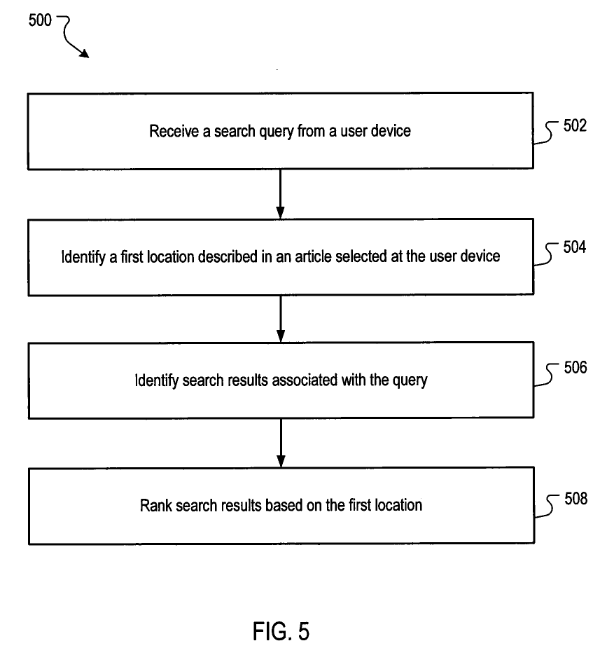

FIG. 5 is a flow diagram of another example process 500 for ranking search results. The process 500 can, for example be performed by the system 200. For illustrative purposes, the process 500 shall be described in reference to the architecture shown in FIG. 1; although it should be understood the process 500 can be applied to different architecture configuration other than FIG. 1.

The process 500 receives a search query from a user device (502). For example, the search interface 202 receives a query including search terms “India” and “news,” and this query is provided to the location module 204 for analysis.

The process 500 identifies a first location described in an article selected at the user device (504). For example, the location module 204 uses the article to identify a first location of the document publisher. In some implementations, the article document can include news content, a blog, a photo, audio content, or other online content.

In some implementations, the first location includes a city, state, or country discussed within the selected content. For example, if a newspaper article discusses a local event, the location module 204 may use geo signal metadata to determine the first location (e.g., a country) where the discussed event occurred, independent of the location of the user device accessing the newspaper article.

The process 500 identifies search results associated with the query (506). For example, the search results module 206 identifies one or more search results associated with the received query. In some implementations, the search results can be identified using standard keyword matching, popularity statistics, search engine settings, and other information narrowing techniques.

The process 500 ranks the search results based on the first location (508). For example, the search results module 206 determines a list of search results and ranks the list in proportion to the relevance between each search result and its respective content. In particular, if the content in a search result discusses the topic of “shopping in India,” the location module 204 may determine that a reader might be interested in viewing more search results relevant to the country of India and its shopping venues and similarly, may wish to view fewer search results relevant to shopping in other countries or regions. Accordingly, the location module 204 can promote the search results that are relevant to India shopping venues or simply relevant to the country of India, and demote other less geographically relevant search results.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal that is generated to encode information for transmission to suitable receiver apparatus for execution by a computer. The computer-readable medium is a machine-readable storage device, a machine-readable storage substrate, a memory device, a composition of matter affecting a machine-readable propagated signal, or a combination of one or more of them.

The term “processing device” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. In some implementations, the steps in FIGS. 4 and 5 can be executed as a batch process, namely the search results can be ranked according to a geo signal and/or a particular geographic location.

What is claimed is:

1. A method implemented by data processing apparatus, the method comprising:
selecting a plurality of documents previously selected by a user wherein each of the selected documents was published by a different newspaper publisher;
determining a respective geographic location for each of the different newspaper publishers;
determining a geographic location of interest for the user based on, at least, the respective geographic locations of the newspaper publishers;
receiving a query from the user device associated with the user;
receiving search results that are responsive to the query;
ranking the search results based on, at least, the determined geographic location of interest for the user;
sending the ranked search results to the user device; and
wherein determining, receiving, obtaining, ranking, and sending are performed by the data processing apparatus.

2. The method of claim 1 wherein ranking the search results comprises increasing respective scores of one or more of the search results that refer to documents that include information about the determined geographic location of interest for the user relative to one or more of the search results that refer to documents that do not include information about the determined geographic location of interest for the user.

3. The method of claim 1 wherein determining the respective geographic location of each of the different newspaper publishers comprises identifying the respective geographic location of the newspaper publisher using metadata from a document published by the newspaper publisher or by searching a database of newspaper publisher geographic locations.

4. The method of claim 1 wherein determining the geographic location of interest for the user comprises determining the geographic location independent of a current location of the user device.

5. The method of claim 1 wherein the geographic location of interest for the user is a country, and wherein ranking the search results comprises promoting one or more of the search results that are relevant to the country.

6. The method of claim 1 wherein a particular previously selected document is a news article document.

7-11. (canceled)

12. A system comprising:
data processing apparatus configured to perform operations comprising:
selecting a plurality of documents previously selected by a user wherein each of the selected documents was published by a different newspaper publisher;
determining a respective geographic location for each of the different newspaper publishers;
determining a geographic location of interest for the user based on, at least, the respective geographic locations of the newspaper publishers;
receiving a query from the user device associated with the user;
receiving search results that are responsive to the query;
ranking the search results based on, at least, the determined geographic location of interest for the user; and
sending the ranked search results to the user device.

13. The system of claim 12, wherein ranking the search results comprises increasing respective scores of one or more of the search results that refer to documents that include information about the determined geographic location of the interest of the user relative to one or more search results that refer to documents that do not include information about the determined geographic location of the interest.

14. The system of claim 12, wherein determining the respective geographic location of each of the different newspaper publishers comprises identifying the respective geographic location of the newspaper publisher using metadata from a document published by the newspaper publisher or by searching a database of newspaper publisher geographic locations.

15. The system of claim 12, wherein determining the geographic location of interest for the user comprises determining the geographic location independent of a current location of the user device.

16. The system of claim 13 wherein the geographic location of interest for the user is a country, and wherein ranking the search results comprises promoting one or more of the search results that are relevant to the country.

17-20. (canceled)

21. The system of claim 13 wherein a particular previously selected document is a news article document.

22. A computer readable medium having instructions stored thereon that, when executed by data processing apparatus, cause the data processing apparatus to perform operations comprising:
selecting a plurality of documents previously selected by a user wherein each of the selected documents was published by a different newspaper publisher;
determining a respective geographic location for each of the different newspaper publishers;
determining a geographic location of interest for a-the user based on, at least, the respective geographic locations of the newspaper publishers;
receiving a query from the user device associated with the user;
receiving search results that are responsive to the query;
ranking the search results based on, at least, the determined geographic location of interest for the user; and
sending the ranked search results to the user device.

23. The computer readable medium of claim 22 wherein ranking the search results comprises increasing respective scores of one or more of the search results that refer to documents that include information about the determined geographic location of interest for the user relative to one or more of the search results that refer to documents that do not include information about the determined geographic location of interest for the user.

24. The computer readable medium of claim 22 wherein determining the respective geographic location of each of the different newspaper publishers comprises identifying the respective geographic location of the newspaper publisher using metadata from a document published by the newspaper publisher or by searching a database of newspaper publisher geographic locations.

25. The computer readable medium of claim 22 wherein determining the geographic location comprises determining the geographic location of interest for the user independent of a current location of the user device.

26. The computer readable medium of claim 22 wherein the geographic location of interest for the user is a country, and wherein ranking the search results comprises promoting one or more of the search results that are relevant to the country.

27. The computer readable medium of claim 22 wherein a particular previously selected document is a news article document.
